(19) United States
(12) Patent Application Publication
(10) Pub. No.: US 2025/0253539 A1
(43) Pub. Date: Aug. 7, 2025

(54) ANTENNA SYSTEMS FOR OBTAINING POSITION INFORMATION USING POLARIZATION LOSS OPTIMIZATION

(71) Applicant: HEWLETT PACKARD ENTERPRISE DEVELOPMENT LP, Spring, TX (US)

(72) Inventors: AHMAD YACOUB, Spring, TX (US); Farhan Hasnain, Santa Clara, CA (US); Deven Patel, Santa Clara, CA (US)

(21) Appl. No.: 18/435,226

(22) Filed: Feb. 7, 2024

(51) Int. Cl. H01Q 15/24; G01S 19/13

(52) U.S. Cl. CPC H01Q 15/244; G01S 19/13

(57) ABSTRACT

Systems and methods are provided for tuning network devices, such as access points (APs). Examples herein receiving, by an antenna of an AP, a circularly polarized signal and obtaining a first linearly polarized component and a second linearly polarized component of the circularly polarized signal. Examples also include identifying a signal having a largest signal power based on a comparison comprising the first and second linearly polarized components, obtaining geographic coordinates for the access points from the identified signal, and connecting to a network based on the obtained geographic coordinates

### BACKGROUND

Obtaining reliable, accurate locations of access points (APs) or other network devices can be useful for many applications, such as rendering of network services and locating other devices on the network, such as client devices. Network device positioning techniques include measuring radio signals transmitted from a variety of devices or entities, including satellites. For example, modern electronic devices include systems that can receive signals from satellite navigation systems, commonly referred to as Global Navigation Satellite Systems (each a “GNSS”), and use the satellite signals to determine the location of the device. GNSS receivers may be integrated into network devices, such as APs or the like. Signals from multiple satellites orbiting the earth may be received and processed by the integrated GNSS receiver to determine the location of the GNSS receiver and, by proxy, the location of the network device.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A and 1B illustrate an example of a network configuration that may be implemented in accordance with the present disclosure.

FIG. 2 illustrates rotation of an electrical field vector of an example circularly polarized electrical signal, which may be an example of a positioning signal in accordance with the present disclosure.

FIG. 3 is a schematic block diagram of an example receiver, in accordance the implementations of the present disclosure.

FIG. 4 illustrates an example computing component that may be used to implement tuning a network device in accordance with various implementations of the present disclosure.

FIG. 5 is a schematic block diagram of another example receiver, in accordance the implementations of the present disclosure.

FIG. 6 is a flow chart of example calibration process, in accordance with an example implementation.

FIG. 7 is a schematic block diagram of another example receiver, in accordance the implementations of the present disclosure.

FIG. 8 is a flow chart of another example calibration process, in accordance with an example implementation.

FIG. 9 is a schematic block diagram of another example receiver, in accordance the implementations of the present disclosure.

FIG. 10 is a flow chart of another example calibration process, in accordance with an example implementation.

FIG. 11 is an example computer system that may be used to implement various features of polarization loss optimization calibration of the present disclosure.

The figures are not exhaustive and do not limit the present disclosure to the precise form disclosed.

### DETAILED DESCRIPTION

Implementations of the present disclosure relate generally to GNSS receivers, integrated into network devices, which are capable of capturing multiple linear components of circular polarized signals for obtaining a location of the GNSS receivers. In various examples, the disclosed implementations can be integrated into a network device, such as an AP or other device connected to a network, positioned in an indoor environment or other environment where a line-of-sight propagation may not be possible with the satellite (or unlikely). Line-of-sight (LoS) propagation refers to characteristics of electromagnetic radiation in which two devices transmit and/or receive signals when in direct view of each other, with no obstacles in between. As used herein, an “obstructed environment” refers to an environment in which LoS propagation may not be possible due to obstructions, such as structures of an indoor environment or any obstruction that may be present between two devices, whether indoor or outdoor.

Implementations disclosed herein may capture multiple linear components of circular polarized signals to determine a rotation direction (sometimes referred to herein as “handedness”) of the circularly polarized signals. The direction of rotation can be leveraged by the disclosed implementations to identify an optimal signal for obtaining a location of the GNSS receivers.

As outlined above, GNSS, such as Global Positioning System (GPS) in the United States or the like, can be used by network devices to obtain location information of itself and/or other the network devices. A GNSS receiver may detect a GNSS signal encoded with location information and decode the detected GNSS signal to obtain location information encoded therein. The location information may be provided as carrier frequency information, satellite identifiers, and navigation data (e.g., satellite orbit data, satellite clock information, satellite health information, which can be used for obtaining location or geographic coordinates of the GNSS receiver.

As alluded to above, GNSS receivers can be integrated into network device, such as APs and the like, for obtaining location information of the network device, as well as surrounding network devices connected thereto. Each network device may have a built-in GNSS receiver to enable location anchoring. In some cases, network devices of a network can be deployed within an indoor environment, such as behind walls, around corners, on ceilings, or other structures. The deployment may obstruct LoS propagation or otherwise hinder LoS propagation between a GNSS receivers installed on the network devices and GNSS satellites. Generally, a network device that is close to a window or otherwise has unobstructed LoS with the satellite can be capable of obtaining more accurate location information relative to other network device that lack LoS propagation with GNSS satellites. In this case, the network device closer to the window (referred to as an anchor network device) may detect GNSS signals and obtain its location information, which can be used to resolve locations of the other APs. For example, the anchor network device may execute Fine Timing Measurement (FTM) measurements and synthesize data to automatically locate other devices on the network (e.g., other APs and connected client devices). For example, each AP have a respective GNSS receiver that performs FTM measurements with neighboring APs to locate itself relative to the neighboring APs. The location may be synchronized with the connected devices to locate these connected devices based on the FTM measurements.

In another example, network devices can use GNSS signals to obtain location information for rendering network services to other connected devices, such as client devices. For example, a network device, implemented as an AP, may be required to self-locate its geographic location using GNSS and report the location for provisioning of frequency bands for use by the AP. For example, the Federal Communications Commission (FCC) defines Unlicensed National Information Infrastructure (U-NII) radio frequency bands of the radio frequency spectrum available for use by network devices. The U-NII consists of either ranges: U-NII 1 through 4 are for the 5 GHz frequency bands and U-NII 5-8 are for the 6 GHz frequency band. For U-NII 5 and 7, Automated Frequency Coordination (AFC) may be required by the FCC guidance, which involves self-locating by an AP and reporting the location to an AFC database along with an FCC identified (FCCID), serial number, and other Vendor Specific Elements (VSE) associated with the AP. An AFC service can then reply back to the AP with a provisioned frequency band and power levels permitted for that AP, so to avoid interfering with incumbent devices on the network. The AP can then use the provisioned frequency band for rendering services on the network.

GNSS signals emitted by GNSS satellites generally employ right-hand circular polarization (RHCP) to transmit signals to earth. The GNSS signals also tend to have relatively small amplitudes due to propagation loss as the GNSS traverses the atmospheric path to network devices on the earth. Hence, conventionally, GNSS receivers may need to be able to receive RHCP signals with sufficient passive gain, low axial ratio between the orthogonal polarized components of the RHCP, and minimal polarization mismatch loss. Furthermore, GNSS receivers generally include low noise amplifiers (LNAs) that apply gain to a received GNSS signal to amplify the signal, which includes amplifying a noise floor imparted onto the GNSS signal due to the traversal to the GNSS receiver. As such, for a GNSS receiver, each decibel of improvement in sensitivity can have a significant effect on accurately detecting a GNSS signal and obtaining the location information encoded thereon. Furthermore, enhancing passive gain of the emitted GNSS signal can have an improved effect on the sensitivity of the GNSS receiver, since the passive gain can function to amplify the GNSS signal emitted by the satellite without raising the noise floor at the GNSS receiver. That is, a component of the received GNSS signal encoded with the location information can be amplified without also amplifying a noise component of the GNSS signal.

In addition, in obstructed environments, GNSS signals may reflect off structures or other obstructions as it travels to a GNSS receiver. However, the polarization of a GNSS signal can change from RHCP to left-handed circular polarization (LHCP) or vice versa with each reflection. The magnitude of the change in rotation direction may be dependent on an angle for reflection or incidence and, as such, a reflected GNSS signal may take on eccentricities anywhere between LHCP and RHCP. Therefore, a GNSS receiver may receive GNSS signals that are RHCP if the GNSS signals are not reflected or if the GNSS signals are reflected an even number of times, or may receive GNSS signals that are LHCP if the signals are reflected an odd number of times. As a result, for obstructed environments, receiving a direct RHCP GNSS signal may be nearly impossible and the GNSS receivers may have to rely on reflected GNSS signals. For example, an indoor AP may have to rely on GNSS signals coming through window or similar open spaces, which are reflected one or more times prior to reaching the AP. Furthermore, each reflection attenuates the GNSS signal, thereby reducing the signal power after each reflection.

In some cases, reflected GNSS signals may become elliptical polarization signals or signals of other polarization states. Thus, the term “GNSS signal” used herein refers to any radio frequency signal conforming to the GNSS technology and having a non-linear polarization state that rotates in left or right handed directions, including circular polarization, elliptical polarization, or unpolarized state. As such, in an obstructed environment, GNSS receivers may receive GNSS signals, emitted from the same satellite, having varying polarization states.

To address the above technical problems, some GNSS receivers employ a linearly polarized antenna coupled in series with an LNA. Examples of linearly polarized antennas include, but are not limited to, a planar inverted-F antenna (PIFA), wire antennas (e.g., dipoles, monopoles, etc.), loop antennas, antenna arrays, patch antennas, slot antennas, aperture antennas (e.g., horn, waveguides, etc.), and the like. These linearly polarized antennas can receive a linearly polarized component of a GNSS signal for use in resolving a location. For example, a linearly polarized antenna may be configured to receive a vertically polarized component of a circularly polarized GNSS signal. In addition, a linearly polarized antenna can receive a linearly polarized component of a GNSS signal independent of polarization rotation direction, and thus can accept both RHCP and LHCP signals. As a result, a linear polarized antenna can account for unknown polarization states resulting from reflections. However, a linearly polarized antenna may experience loss in signal power due to polarization mismatch. For example, in the case of a RHCP or LHCP GNSS signal, up to half of the signal power may be lost (e.g., up to 3 dB loss) at the linearly polarized antenna before reaching the LNA. The amount of power loss may vary dependent on the polarization state of the received GNSS signal (e.g., circular polarization compared to elliptical).

While RHCP antennas can more efficiently receive RHCP GNSS signals with little loss caused by polarization mismatch, RHCP GNSS antennas may be unable to receive LHCP GNSS signals due to polarization mismatch. Further, signal power diminishes with each reflection, such that after two reflections there may not be sufficient signal power to distinguish location information encoded on the GNSS signal from the noise floor. Therefore, RHCP antennas may not adequately address the above discussed technical problems in obstructed environments. For example, RHCP antennas may be only as good as the direction it points relative to a satellite. Thus, RHCP antennas can be most efficient when pointing up to the sky toward satellites. However, in many indoor environments, antennas are mounted on a ceiling, in which case the antenna may be directed in a downward direction toward a floor. Thus, ceiling mounted antennas may be reliant on transverse or reflected GNSS signals, and RHCP antennas may lose efficiency in these configurations.

Accordingly, implementations disclosed herein provide for a network device that comprises a receiver, such as a GNSS receiver, configured to capture a plurality of linearly polarized components of a received circularly polarized signal. As a result, the disclosed implementations provide for receiving GNSS signals with increased signal power relative to a single linearly polarized component. In various examples, the network device may be an AP configured to obtain location information of the AP from a GNSS signal received according to the examples disclosed herein. In examples, the AP may be configured to connect to a network based on the obtained location information. In other examples, the AP may be configured to determine location of other network devices on a network based on the received GNSS signal.

In various examples, a receiver comprises a dual-polarized antenna configured to capture two linearly polarized components of a GNSS signal. For example, the dual-polarized antenna may obtain a first linearly polarized component and a second linearly polarized component of the circularly polarized signal. The linearly polarized components may be orthogonally polarized relative to each other (e.g., vertical and horizontal components). Thus, the disclosed implementations may capture two linearly polarized components of GNSS signals independent of polarization rotation direction.

The network devices of the present disclosure may comprise a controller (e.g., a processor or other computing component). The controller can be configured to identify a signal having the largest signal power based on a comparison comprising the first and second linearly polarized components. The controller may be configured to calibrate the receiver according to the identified signal. The receiver may be configured to demodulate the identified signal to obtain location information encoded thereon (e.g., carrier frequency information, satellite identifiers, and navigation data—such as satellite orbit data, satellite clock information, satellite health information, which can be used for obtaining location or geographic coordinates).

The controller may utilize various methods for identifying a signal based on a comparison comprising the first and second linearly polarized components. For example, the controller may be configured to compare amplitudes of the first and second linearly polarized components to determine which linearly polarized signal has the largest signal power. The controller may then calibrate the receiver so to use the identified linearly polarized signal, which can be used to obtain geographic coordinates. For example, the controller may calibrate the receiver to enhance a signal received from a specific satellite. The receiver can then be operated to receive signals from multiple satellites simultaneously and stitch together signals received at different points in time for obtaining geographic coordinates.

In another example, the controller may identify a signal based on applying a phase delay on a linearly polarized component. For example, the controller may be configured to iteratively apply a plurality of phase delays to the first linearly polarized component. For each phase delay, the phase delayed first linearly polarized component can be combined with the second linearly polarized component to generate a combined signal. The controller may then determine a signal power of each combined signal and identify a combined signal having the largest signal power. The controller can then calibrate the receiver to use the identified combined signal.

In yet another example, the controller may identify a signal based on combining the linearly polarized components to create a combined circularly polarized signal. For example, the first and second linearly polarized components can be input into first and second inputs of a switch (e.g., a diamond switch as known in the art). Outputs from the switch can be combined to provide a first combined circularly polarized signal. The inputs may then be flipped to output a second combined circularly polarized signal. The signal powers of the first and second combined circularly polarized signals can be compared to identify which is larger. The controller can then calibrate the receiver to use the combined circularly polarized signal having the largest signal power.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

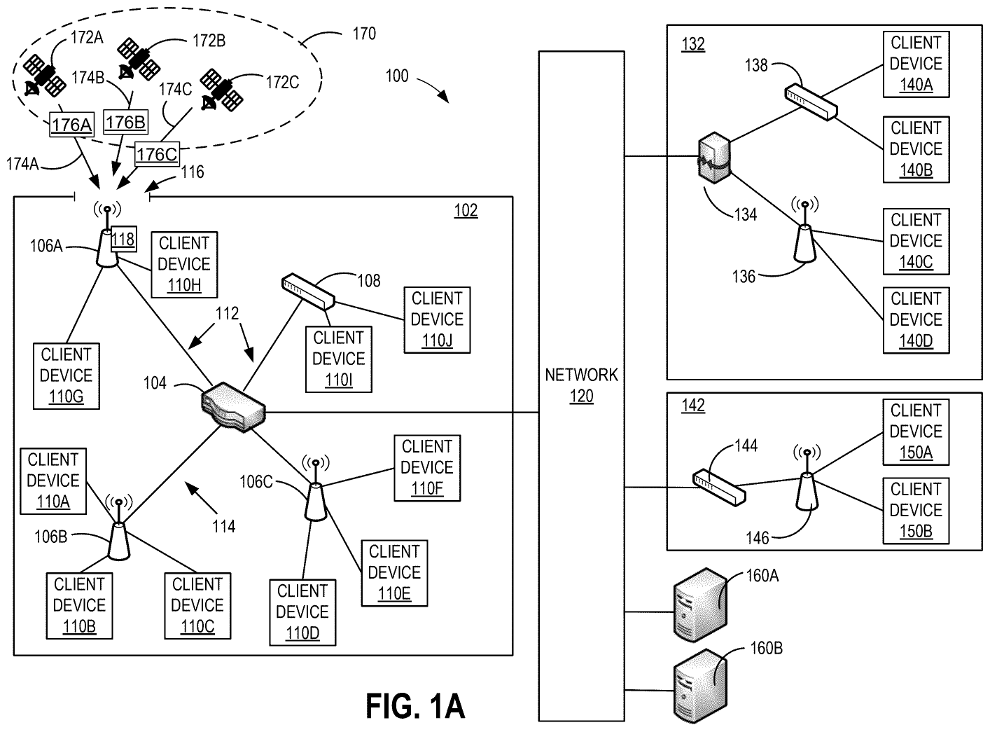

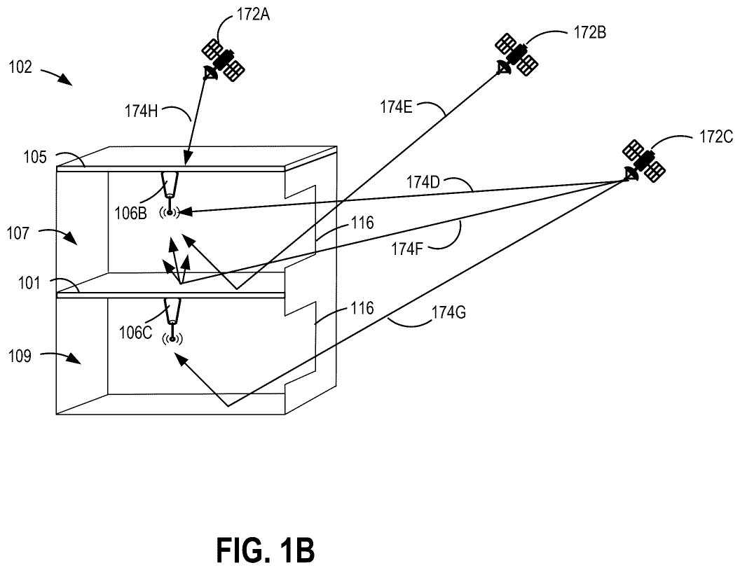

Before describing examples of the disclosed systems and methods in detail, it is useful to describe an example network installation (also referred to as a deployment) with which the disclosed systems and methods might be implemented in various applications. FIGS. 1A and 1B illustrate an example of a network configuration 100 that may be implemented for an organization, such as a business, educational institution, governmental entity, healthcare facility or other organization. The organization of the network configuration 100 may include multiple users (or at least multiple client devices 110) and possibly multiple physical or geographical sites, such as primary site 102, remote site 132, and remote site 142. The network configuration 100 may include a primary site 102 in communication with a network 120. The network configuration 100 may also include one or more remote sites 132, 142, that are in communication with the network 120. The network 120 may allow each geographical site of the network configuration 100 of an organization to communicate with one another.

The primary site 102 may include a primary network, which can be, for example, an office network, home network or other network installation. The network of the primary site 102 may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a network controller 104 in communication with the network 120. The network controller 104 may provide communication with the network 120 for the primary site 102, though the network controller 104 may not be the only point of communication with the network 120 for the primary site 102. A single network controller 104 is illustrated, though the primary site 102 may include multiple controllers and/or multiple communication points with network 120. In some examples, the network controller 104 communicates with the network 120 through a router (not illustrated). In other examples, the network controller 104 provides router functionality to the devices, such as client devices 110, in the primary site 102.

A network controller 104 may be operable to configure and manage network devices, such as at the primary site 102, and may also manage network devices, such as gateway device 134, access points (APs) 136, switch 138, gateway device 144 and AP 146, at the remote sites 132, 142. The network controller 104 may be operable to configure and/or manage switches, routers, access points, and/or client devices connected to a network. The network controller 104 may itself be, or provide the functionality of, an AP.

The network controller 104 may be in communication with one or more switches 108 and/or wireless APs 106A-C. Switches 108 and wireless APs 106A-C may provide network connectivity to various client devices 110A-J. Using a connection to a switch 108 or AP 106A-C, a client device of client devices 110A-J may access network resources, including other devices on the network of primary site 102 and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IoT) devices, and the like. Client vendors may connect to the network of the primary site 102, the network of the remote site 132, and/or the network of the remote site 142 an organization using client devices, such as client devices 110A-J, client devices 140A-D, and/or client devices 150A-B.

Within the primary site 102, a switch 108 is included as one example of a point of access to the network established in primary site 102 for wired client devices 1101-J. Client devices 1101 and 110J may connect to the switch 108 and through the switch 108, may be able to access other devices within the network configuration 100. The client devices 1101 and 110J may also be able to access the network 120, through the switch 108. The client devices 1101 and 110J may communicate with the switch 108 over a wired connection 112. In the illustrated example, the switch 108 communicates with the network controller 104 over a wired connection 112, though this connection may also be wireless.

Wireless APs 106A-C are included as another example of a point of access to the network established in primary site 102 for client devices 110A-H. Each of APs 106A-C may be a combination of hardware, software, and/or firmware that is configured to provide wireless network connectivity to wireless client devices 110A-H. In the illustrated example, APs 106A-C can be managed and configured by the network controller 104. APs 106A-C may communicate with the network controller 104 and the network of primary site 102 over connections 112, which may be either wired or wireless interfaces.

The network configuration 100 may include one or more remote sites, such as remote site 132. Remote site 132 may be located in a different physical or geographical location from the primary site 102. In some cases, the remote site 132 may be in the same geographical location, or possibly the same building, as the primary site 102, but lacks a direct connection to the network of the primary site 102. Instead, remote site 132 may utilize a connection over a different network, e.g., network 120, to connect to the network of the primary site 102. The remote site 132 may be, for example, a satellite office, another floor or suite in a building, and so on. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 may provide connectivity to the network for various client devices 140A-D.

In various examples, the remote site 132 may be in direct communication with the primary site 102, such that client devices 140A-D at the remote site 132 access the network resources at the primary site 102 as if clients devices 140A-D were located at the primary site 102. In such examples, the remote site 132 may be managed by the network controller 104 at the primary site 102, and the network controller 104 may provide the necessary connectivity, security, and accessibility that enables the communication of the remote site 132 with the primary site 102. Once connected to the primary site 102, the remote site 132 may function as a part of a private network provided by the primary site 102.

In various examples, the network configuration 100 may include one or more smaller remote sites, such as remote site 142, comprising only a gateway device 144 for communicating with the network 120 and a wireless AP 146, by which various client devices 150A-B may access the network 120. Such a remote site 142 may represent, for example, an individual employee's home or a temporary remote office. The remote site 142 may also be in communication with the primary site 102, such that the client devices 150A-B at remote site 142 access network resources at the primary site 102 as if these client devices 150A-B were located at the primary site 102. The remote site 142 may be managed by the network controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 132 and 142 as well as access to servers, such as servers 160A-B. Servers 160A-B can also be appliances and/or nodes for remote computation, which can be executed to perform the functions disclosed herein. Thus, the implementation disclosed herein can be run directly on APs 106A-C, on servers 160A and/or 160B, or distributed on AP and servers in a post processing manner. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers such as servers 160A-B. Servers 160A-B may include various providers of multimedia downloadable and/or streaming content, including audio, video, graphical, and/or text content, or any combination thereof. Examples of servers 160A-B may include, for example, web servers, streaming radio and video providers, and cable and satellite television providers. The client devices 110A-J, 140A-D, 150A-B may request and access the multimedia content provided by the servers 160A-B through the network 120.

Although ten client devices 110A-J are illustrated at primary site 102 in the example of FIG. 1A, in various applications, a network may include a lesser or greater quantity of client devices. Indeed, some implementations may include a dramatically larger quantities of client devices. For example, various wireless networks may include hundreds, thousands, or even tens of thousands of clients communicating with their respective APs, potentially at the same time.

Network configuration 100 can include a positing system 170 configured to provide location information of network devices shown in FIG. 1A. For example, as shown in the example of FIG. 1A, AP 106A comprises a receiver 118 that can receive positioning signals from positioning system 170, which can be used by receiver 118 to resolve a location of the receiver 118 and, by extension, AP 106A. While a single receiver is depicted in FIG. 1A, other receivers may be similarly be provided in the other network devices of FIG. 1A, such as other APs 106B-106C, switch 108, etc. Location information may be provided as a latitude and longitude, and possibly altitude, of the receiver (e.g., receiver 118). Location information may also be provided as a relative location of the receiver such as a location expressed as distances north or south, east or west and possibly above or below some other known fixed locations. A location may also be specified as a geodetic location (as a latitude and longitude), as a civic location (e.g., in terms of a street address or using other location related names and labels), as a local location (e.g., in terms of distances from known structures or objects in an environment, such as building having an indoor environment consisting of walls, ceilings, etc.).

Positioning system 170 can include one or more satellites, such as satellites 172A-172C (collectively referred to as satellites 172 or individually referred to as a satellite 172). Each satellite 172A-172C can transmit a respective positioning signal 174A-174C to network devices. The position signals 174A-174C may include location information 176A-176C, respectively. A receiver, such as receiver 118, may detect the positioning signals 174A-174C, obtain location information 176A-176C encoded thereon, and estimate a location of the receiver based on the received location information 176A-176C. For example, receiver 118 may receive positioning signals 174A-174C and demodulate each positioning signal 174A-174C to obtain location information 176A-176C. Location information 174A-174C may include, but not limited to, information that can be used to resolve geographic coordinates of the receiver 118. For example, each signal 174A-174C may include carrier frequency information, a satellite identifier, and navigation data (e.g., satellite orbit data, satellite clock information, satellite health information, which can be used for obtaining location or geographic coordinates of the receiver 118. Based on the location information, receiver 118 may resolve (e.g., estimate) its current geographic location. For example, location information 174A-174C obtained from multiple satellites 172 can be used to resolve geographic coordinates of the receiver 118.

In the example of FIG. 1A, three satellites are depicted for illustrative purposes. However, positioning system 170 may comprise any number of satellites 172. Positioning system 170 may include, for example, a constellation of satellites 172 in synchronized orbits to transmit electromagnetic signals (e.g., positioning signals 174A-174C) to locations on a vast portion of the Earth's surface simultaneously from multiple satellites in the constellation. A satellite, as a member of a particular positioning system, may transmit positioning signals in a format that is unique to the particular positioning system. A receiver (e.g., receiver 118) may be used to determine the absolute location, as well as the relative location of a network device in which the receiver is installed. For example, satellites 172 may broadcast positioning signals 174A-174C, which can be received by receiver 118. The receiver 118 may determine the absolute position of AP 106A by processing the positioning signals 174A-174C. Satellites 172A-172C may orbit at altitudes, for example, from about 20,000 km to about 23,000 km, and may have known time and ephemerides. Satellites 172A-172C may broadcast positioning signals 174A-174C that include pseudorandom patterns. The positioning signals 174A-174C may include carrier frequencies in the L-band, such as 1575.42 MHz (L1), 1227.6 MHz (L2), or 1176.45 MHz (L5) modulated at about 1 MHz and/or about 10 MHz. Because the satellites are always in motion, the receiver 118 may continuously acquire and track the positioning signals 174A-174C from the satellites 172. The receiver 118 can demodulate the received positioning signals 174A-174C to obtain the location information 174A-174C and compute its distance to a set of satellites based on the speed of the electromagnetic wave (e.g., speed of light) and the propagation time (e.g., time-of-flight) of the incoming signals travelling through space that may be determined using the satellite and receiver local clocks.

In various examples, positioning system 170 may be a GNSS and satellites 172 may be GNSS satellites. GNSS satellites may be, for example but not limited to, satellites for the Global Position System (GPS, United States), Galileo (European Union), Glonass (Russia), Beidou (China), or the like. In these examples, satellites 172 may broadcast positioning signals 174A-174C as GNSS signals, which typically have a RHCP polarization, The receiver 118, as well as other receivers that may be deployed in the network devices of FIG. 1A, may be an GNSS receiver. For example, receiver 118, implemented as a GNSS receiver, may receive broadcast GNSS signals from satellites 172A-172C, respectively. Based on the GNSS signals, receiver 118 may determine the absolute position AP 106A by demodulating the received signals 174A-174C to obtain location information 176A-176C.

While the examples described herein are with reference to APs 106 obtaining location information from a positioning system 170, the present disclosure is not intended to be limited to this implementation alone. APs 106 are provided as an illustrative example and other network devices may be implemented to receive positioning signals from satellites of positioning system 170. For example, switch 108, switch 138, AP 136, gateway device 144, and etc. may each comprise a receiver, such as receiver 118, for receiving positioning signals and estimating a location of a corresponding network device.

The network devices may be configured to utilize obtained location information in providing services and functionality of the respective network device. As an example, APs 106A-106C may detect positioning signals and obtain their respective location information, which can be used to resolve locations of the other APs or network devices on network 120. In an illustrative example, receiver 118 of AP 106A may receive and detect positioning signals 174A-174C and estimate its position based on location information 176A-176C contained thereon. AP 106A may be considered an anchor AP, which can use its location to resolve locations of other network devices on network 120, such as but not limited to, other APs, switches, client devices, etc. AP 106A may execute Fine Timing Measurement (FTM) measurements and synthesize data based on the FTM measurements to locate other network devices and estimate their positions.

As another example, network devices, such as APs 106A-106C, can use their respective location information for rendering network services to connected network devices, such as client devices 110A-110J. For example, APs 106A-106C may be required to self-locate by estimating their geographic location and report the location for provisioning of frequency bands for use by the APs 106A-106C. The FCC defines U-NII radio frequency bands of the radio frequency spectrum available for use by network devices, such as APs 106A-106C. The U-NII consists of either ranges: U-NII 1 through 4 are for the 5 GHz frequency bands and U-NII 5-8 are for the 6 GHz frequency band. For U-NII 5 and 7, AFC may be required by FCC guidance. Under AFC, APs 106A-106C may be required to determine a geographic position and self-report this position to an AFC database along with an FCCID, serial number, and other VSE associated with the respective AP. An AFC service can then reply back to APs 106A-106C with a provisioned frequency band and power levels permitted for each APs 106A-106C, so to avoid interfering with incumbent devices on the network. The APs 106A-106C can then provide network services to other network devices using the provisioned frequency band.

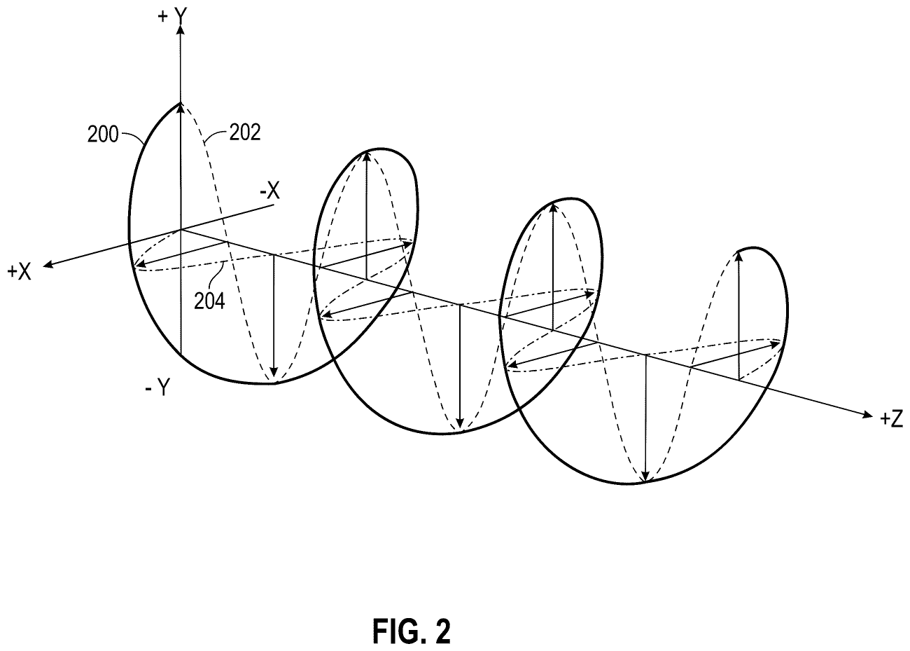

As alluded to above, positioning signals, such as GNSS signals, typically propagate with circular polarization. FIG. 2 illustrates rotation of an electrical field vector of an example circularly polarized electrical signal 200, which may be an example of a positioning signal (e.g., positioning signals 174A-174C). In this example, circularly polarized electrical signal 200 is propagating in the +Z direction. Circularly polarized electrical signal 200 may include a first component 202 with the electrical field oscillating in a first plane (e.g., a vertical plane shown as the Y-Z plane in this example) and a second component 204 with the electric field oscillating in a second plane orthogonal to the first plane (e.g., the X-Z plane in this example). Thus, first component 202 and second component 204 may be both linearly polarized and synchronized to each other. Depending on the phase and/or amplitude difference between first component 202 and second component 204, the combined electrical wave may be linearly polarized, circularly polarized, or elliptically polarized. For example, when the phases of first component 202 and second component 204 are the same, the combined electrical wave may be a linearly polarized wave, where the electric field vector points in the same direction. As another example, where the amplitudes differ, the combined electrical wave may be elliptically polarized.

In circular polarization signals, an electric field of the two orthogonal vector components 202 and 204 may not peak at the same time, but may peak 90° (e.g., % wavelength) apart relative to each other. Instead, the resultant combined vector of the two components 202 and 204 may rotate 360° per wavelength during the propagation, shown as circularly polarized electrical signal 200. The direction or handedness (e.g., right-handed or left-handed) of the circular rotation may be determined depending on whether the first component 202 or the second component 204 peaks earlier. For example, where the second component 204 peaks first, followed by the first component 202, the electromagnetic wave may have be RHCP. Whereas, where the first component 202 peaks first relative to the second component 204, the electromagnetic wave may have be LHCP.

Circularly polarized signals may be more tolerant to physical orientation mismatches between transmitting antenna (e.g., at the satellite) and a receiving antenna at a receiver. For example, if a satellite transmits a signal with vertical polarization, a vertically oriented linear antenna may receive a strong signal, but if the receiving antenna is orientated at an angle relative to vertically then the received signal strength may be reduced (e.g., the received signal strength may be reduce by more than 20 dB if the antenna is horizontally orientated. Whereas, if a satellite transmits a circular polarization signal, a receiver with a linear antenna may receive the signal whether the linear antenna is vertically or horizontally orientated, but only the component of the circularly polarized signal aligned with the linear orientation of the receiving antenna.

In obstructed environments reflections may be inevitable as signals reflect off of surfaces in the environment. Some receivers may not have LoS with a satellite and thus may only receive reflected signals. The direction of circular rotation may change due to the reflections, such that a RHCP electromagnetic wave may flip to LHCP upon reflecting off a structure of object. In other cases, the direction of the circular rotation may be change due to reflections, such that the direction of rotation received by a receiver is flipped.

For example, referring back to FIGS. 1, network devices can be deployed in an obstructed environment, the boundaries of which are illustratively shown as site 102. As an illustrative example, site 102 may be an indoor environment, such as an office, facility, or any physical structure (e.g., a building) having an opening 116 (e.g., a window or doorway) to the outside environment. In this example, AP 106A may be positioned close to opening 116, which provides for unobstructed LoS propagation with satellites 172 as shown in FIG. 1A. Whereas, AP 106B, AP 106C, and switch 108 may be deployed elsewhere in the obstructed environment a distance from the opening 116 leading to obstructed LoS propagation. For example, AP 106B may be deployed on a wall around a corner, such that another wall lies between the AP 106B and the satellites 172. In another example, AP 106B and/or AP 106C may be deployed on ceiling with an antenna directed down toward the floor (as shown in FIG. 1B).

Obstruction of LoS propagation between receivers installed on the network devices of FIG. 1A and satellites, such as satellites 172, may negatively impact the receivers' ability to receive positioning signals (e.g., positioning signals 174A-174C) and obtain the location information encoded thereon. Positionings signals, such as those emitted by satellites 172, generally employ RHCP and, in obstructed environments, positioning signals may be reflected prior to being reaching a receiver causing a switch from RHCP to LHCP or vice versa. As a result, receiving a direct RHCP positioning signal in this environment may be nearly impossible.

For example, as shown in FIG. 1B, APs 106C and 106B may have to rely on positioning signals coming through opening 116, which may be reflected one or more times prior to reaching the respective AP. In the illustrative example of FIG. 1B, AP 106B is deployed on a ceiling 105 of a room 107 of primary site 102 and AP 106C is deployed on a ceiling 101 of room 109. Antennas of APs 106B and 106C may be directed toward the floor. In this case, for example, AP 106B may receive positioning signal 174D as a direct LoS transliteral reception, in which positioning signal 174D has nearly linear polarization. Alternatively, or in combination with positioning signal 174D, AP 106B may receive positioning signal 174E, which enters through opening 116 and reflects off the floor before being received by AP 106B. AP 106C may similarly receive a reflected positioning signal 174G. These reflected signal may be skewed LHCP. As another example, positioning signal 174F may be scatter upon incident with the floor. Scattered signals may be linearly polarized. AP 106B may also receive a direct vertical reception that is RHCP, such as positioning signal 174H; however, this signal will be attenuated due to passing through the ceiling 105. Thus, receiving a direct RHCP positioning signal having sufficient signal power to obtain location information encoded therein in this environment may be nearly impossible.

While circularly polarized antennas may be implemented in the APs 106A-106B to efficiently receive circularly polarized electronic signals, the antennas may need to be orientated according to the rotation direction of the circular polarization. Otherwise, the antennas may be unable to receive the transmitted positioning signal due to polarization orientation mismatch. Furthermore, signal strength/power (e.g., amplitude) may diminish with each reflection, such that, after two reflections, a signal may not have sufficient signal power for a receiver to distinguish between the information encoded on the signal and the noise floor.

Thus, linear polarized antennas, such as but not limited to patch antennas, inverted-F antennas (IFAs), PIFAs, wire antennas, loop antennas, antenna arrays, patch antennas, slot antennas, aperture antennas, etc., may be implemented in receivers for detecting circularly polarized electromagnetic signals at network devices of FIG. 1. As noted above, a linear polarized antenna can accept RHCP, LHCP, elliptically polarized, and/or linear polarized signals. Particularly in obstructed environments (e.g., as described in the example of site 102 of FIG. 1A as described above), linear polarized antennas may be useful for receiving RHCP signals via LoS propagation, as well as LHCP signals resulting from reflections. However, a linear polarized antenna having a single polarization may detect only one component of a circularly polarized signal (e.g., one of first component 202 or second component 204 dependent on the orientation of the linear polarized antenna). Thus, there may be as much as a 3 dB loss in the signal level received by a linearly polarized antenna (e.g., half of the power of the circularly polarized signal).

Accordingly, examples of the present disclosure provide receivers comprising an antenna configured to capture (e.g., detect) a plurality of linearly polarized components of a received circularly polarized electromagnetic signal. For example, receiver 118 may comprise an antenna capable of detect a plurality of linearly polarized components of positioning signals 174. Such antennas may be referred to herein as multi-polarized antennas. In some examples, a multi-polarized antenna may be implemented as a dual-polarized antenna configured to capture two linear components of a circularly polarized electromagnetic signals (e.g., vertical and horizontal components).

As an example, with reference to FIG. 1B, AP 106B and AP 106B may include receivers (e.g., receiver 118) capable of detect a plurality of linearly polarized components. In the case of positioning signal 174E (e.g., translational reception), a component of the linearly polarized positioning signal 174E may be aligned (e.g., matched) with one or more of the polarizations of the antenna of AP 106C. Similar situation may occur for the scatter positioning signal 174F. In the case of reflected positioning signals 174D and 174G that are skewed LHCP, the LHCP will be eccentric to the linear components of the antennas, such that one or more components of the reflected positioning signals 174D and 174G can be captured.

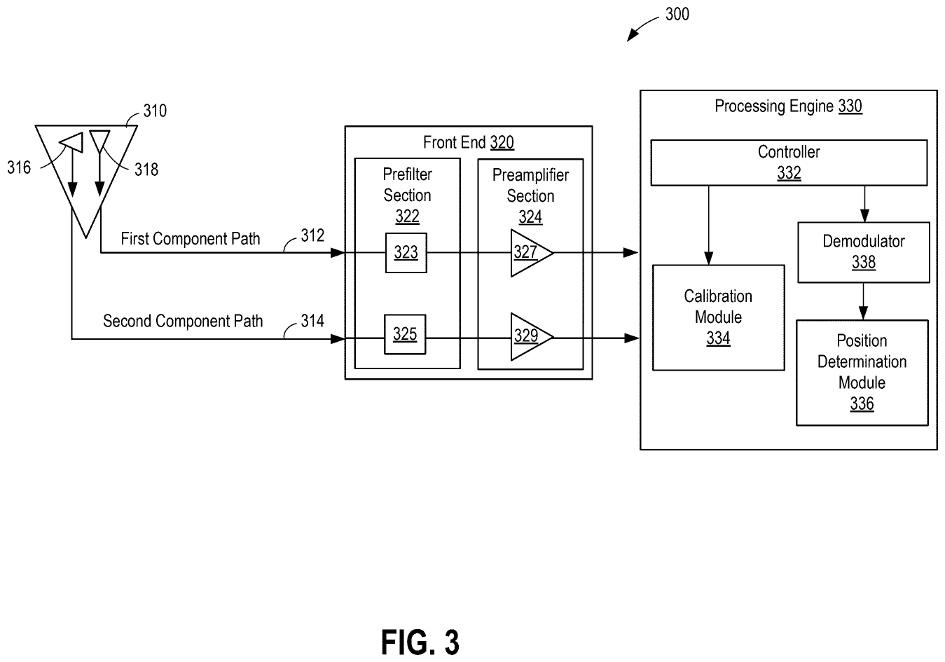

FIG. 3 is a schematic block diagram of an example receiver 300, in accordance the implementations of the present disclosure. Receiver 300 may be included (e.g., installed, embedded, or otherwise affixed to) in network devices, such as APs 106A-106C or other network devices of FIG. 1A, and configured to receiver position signals, such as 174A-174C. In an example implementation, receiver 300 may be a GNSS receiver capable for receiving GNSS signals and extracting location information from the incoming signal. As described above, a GNSS receiver may be configured to estimate a geographic position of the GNSS receiver based on the location information extracted from the GNSS signal, which can be extended to the network device on which the GNSS receiver is embedded.

Receiver 300 may include an antenna 310, a radio frequency (RF) front end 320 and processing engine 330. RF front end 320 and processing engine 330 may each include various modules that may be implemented in hardware, software, or combinations thereof.

Antenna 310 may be configured to receive circularly polarized signals, such as those transmitted by satellites 172 of FIG. 1A. Antenna 310 may be configured to be able to receive signals in different frequency bands, polarizations, and elevation angles. Antenna 310 may be implemented as a multi-polarized antenna configured to receive a circularly polarized signal (e.g., RHCP and/or LHCP signal) and capture a plurality of linearly polarized components of the circularly polarized signal. For example, antenna 310 may be a dual-polarized antenna configured to capture a first component and a second component of a circularly polarized signal. For example, antenna 310 may comprise a first linear component 318 that is orientated in a first direction and a second linear component 316 that is orientated in a second direction. The first linear component 318 can be orientated so as to detect the first component of the circularly polarized signal, while the second linear component 316 can be orientated so detect the second component of the circularly polarized signal. As an illustrative example, the first component may be a vertical component and the second component may be a horizontal component. Thus, in this example, the first linear component 318 may be a vertically orientated component of antenna 310 and the second linear component 316 may be a horizontally orientated component of antenna 310. In some examples, antenna 310 may be implemented as a dual-polarized cross dipole antenna, dual pin patch antenna, or other dual-polarized antenna as known in the art.

The antenna 310 may be electrically connected to the RF front end 320 by a plurality of component paths, each component path corresponding to a captured linear polarized component of the circularly polarized signal. In the example of FIG. 3, receiver 300 comprises a first component path 312 and second component path 314 over which the first and second components of the signal captured by the antenna 310 can be transmitted to the RF front end 320, respectively. In a case of more than two components, additional component paths may be included.

RF front end 320 may include a pre-filter section 322 and a preamplifier section 324. Pre-filter section 322 may include a plurality of filters 323 and 325 that may be configured to filter the received signal from antenna 310 to remove signals outside carrier frequency band (e.g., L band) associated to the antenna 310, reduce the impact of aliasing, and limit the noise bandwidth. For example, filter 323 may be connected to the first component path 312 and receive the first component of the circularly polarized signal. Filter 323 may be configured to filter the first component to remove signals outside carrier frequency band of the antenna 310, reduce the impact of aliasing, and limit the noise bandwidth. While filter 325 may be connected to the second component path 314 and receive the second component of the circularly polarized signal. Filter 325 may be configured to filter the second component to remove signals outside carrier frequency band of the antenna 310, reduce the impact of aliasing, and limit the noise bandwidth.

Preamplifier section 324 may generally include a plurality of low-noise amplifiers (LNA) 327 and 329 configured to amplify the signals filtered by the pre-filter section 322 to increase the signal strength (also referred to as signal power) to levels suitable for downstream processing. For example, LNA 327 may receive a filtered first component from the filter 323 and amplify the signal to a suitable level for processing. Similarly, LNA 329 may receive a filtered second component from the filter 325 and amplify the signal to a suitable level for processing.

Suitable level for processing may be refer to a signal power level received from a satellites being within a sensitivity level of the receiver to decode the signal accurately. The higher the signal level is for a received signal, the more accurate a location can be determined by the receiver. As an illustrative example, a minimum received signal at antenna may be around −128.5 dBm for L1 signals and −127 dBm for L5 signals. After going through filtering and amplification, an example nominal value of carrier to noise level would be around 40-45 dB for L1 and 42-47 dB for L5.

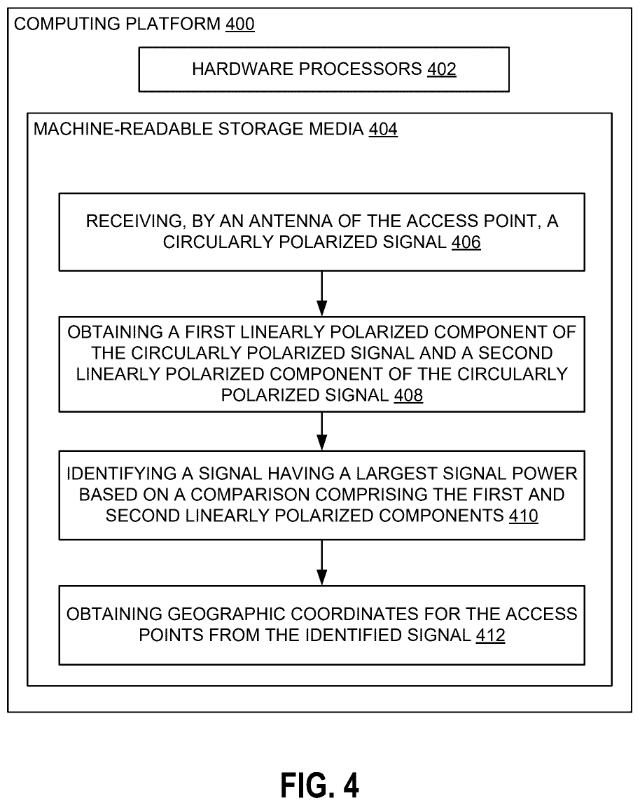

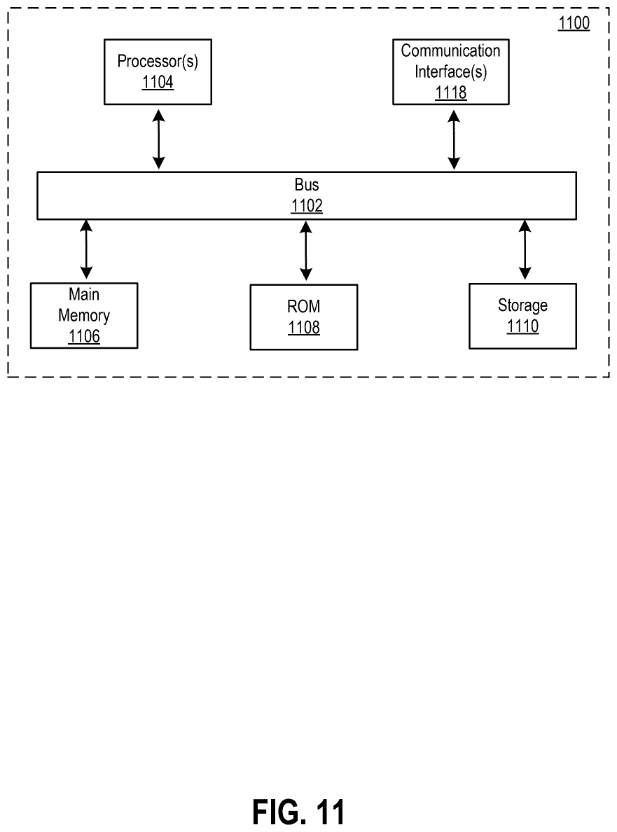

The processing engine 330 may include, for example, a controller 332 configured to execute a calibration module 334 and/or a position determination module 336. The controller 332 may be, for example, a processor or other computing system (e.g., computer system 1100 of FIG. 11). The controller 332 may execute a calibration process at calibration module 334 based on the first and second components of the circular polarized signal output from the front end 320. For example, based on a comparison comprising the first and second components, the controller 332 execute a calibration module 334 to identify a signal having a largest signal power. Additional details on example calibration processes executed by the calibration module 334 are provided below in connection with FIGS. 4, 6, and 8.

The controller 332 may also execute position determination module 336 to determine a position of receiver 300 based on the circular polarized signal received by antenna 310. For example, position determination module 336 may execute a process to determine a position of the receiver 300 based on the signal identified during the calibration process. For example, the position determination module 336 may be executed to obtain location information from the identified signal, which receiver 300 can use to estimate its current position. In an example, controller 332 may execute a demodulator 338 to demodulate the identified signal and decode the location information contained on the signal by position determination module 336. Position determination module 336 may then estimate a position of the receiver 300 using the decoded location information, as described above.

Accordingly, receiver 300 can be able to resolve its position regardless of the rotation direction of the circularly polarized signal because the antenna 310 is able to capture multiple linear components. Thus, regardless of the rotational direction of a circularly polarized signal, the antenna 310 can capture various components of the incoming signal and process the components separately to identify the optimal signal for use in determining a position.

FIG. 4 illustrates an example computing component that may be used to implement tuning (e.g., calibrating) a network device in accordance with various implementations of the present disclosure. Referring now to FIG. 4, computing component 400 may be, for example, a controller (e.g., network controller 104 of FIG. 1A and/or controller 332 of FIG. 3), or any other similar computing component capable of processing data. The computing component 400 may be included as part of a network device, such as those described in connection with FIG. 1A (e.g., an AP or otherwise). In the example implementation of FIG. 4, the computing component 400 includes a hardware processor 402, and machine-readable storage medium 404. In some examples, the computing component 400 may not necessarily comprise the machine-readable storage medium 404, and may be communicatively coupled (e.g., via wired or wireless connection) to machine-readable storage medium 404.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-412, to control processes or operations for tuning a network device. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-412.

Hardware processor 402 may execute instruction 406 to receive, by an antenna, a circularly polarized signal. In various examples, the network device may comprise a receiver, such as receiver 300 of FIG. 3. As such, the antenna may be implemented as antenna 310. The circular polarized signal may be a GNSS signal that is a RHCP GNSS signal.

Hardware processor 402 may execute instruction 408 to obtain a first linearly polarized component of the circularly polarized signal and a second linearly polarized component of the circularly polarized signal. The first linearly polarized component may be orthogonal to the second linearly polarized component, for example, the first linearly polarized component may be a vertical polarized component and the second linearly polarized component may be a horizontally polarized component or vice versa. In some examples, the antenna may receive the circularly polarized signal and capture the first and second linearly polarized components therefrom. For example, the antenna may be a dual-polarized antenna that detects the first and second linearly polarized components.

Hardware processor 402 may execute instruction 410 to identify a signal having a largest signal power based on a comparison comprising the first and second linearly polarized components.

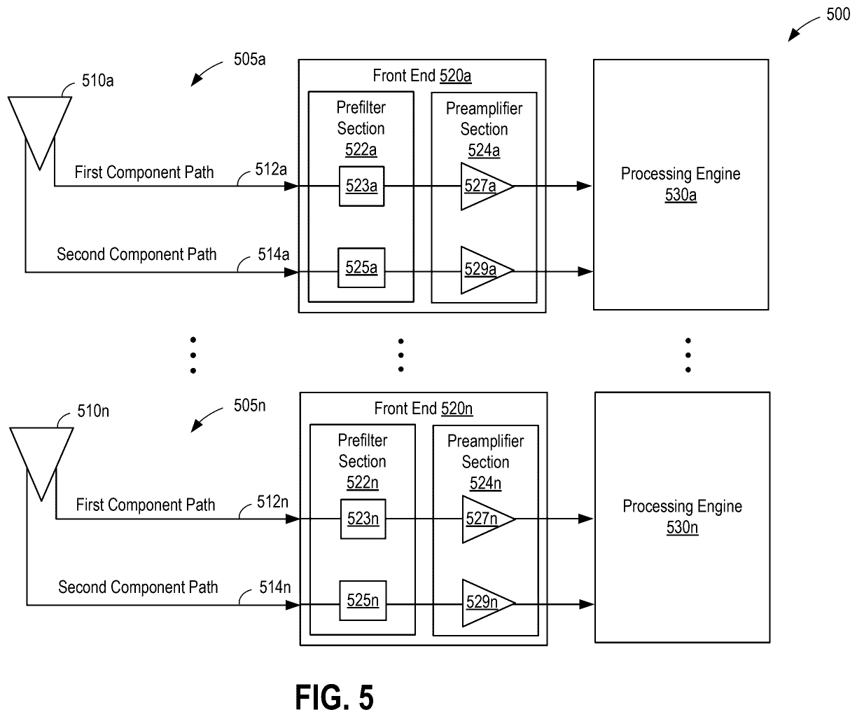

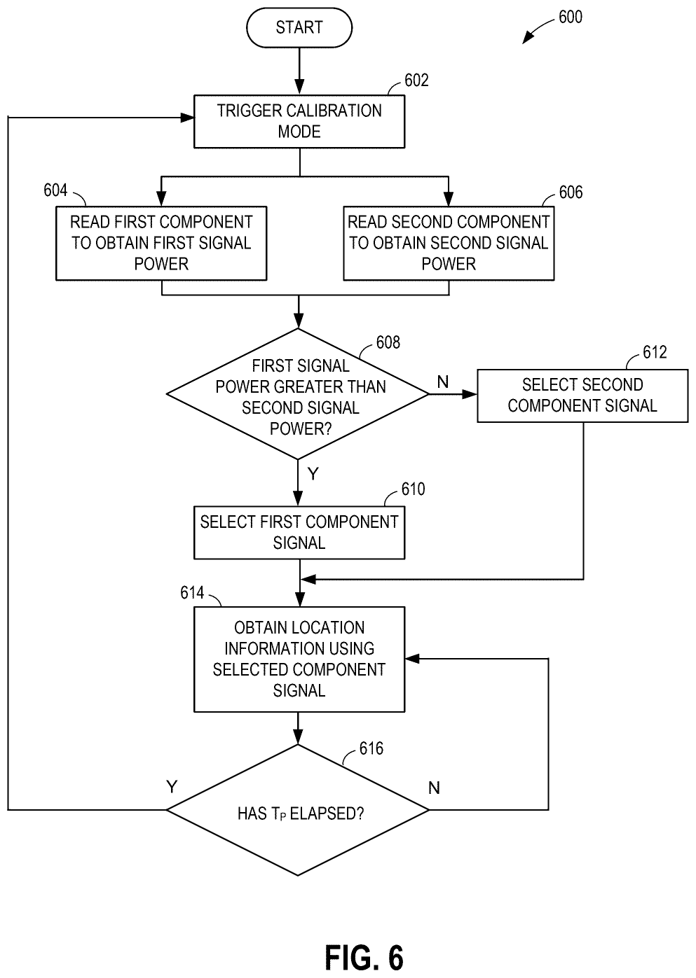

In some examples, hardware processor 402 may execute instruction 410 to determine a first signal power of the first linearly polarized component and a second signal power of the second linearly polarized component. The first and second signal powers can be compared to identify which is largest and the component having the largest signal may considered the identified signal. Additional details of this example are provided below in connection with FIGS. 5 and 6.

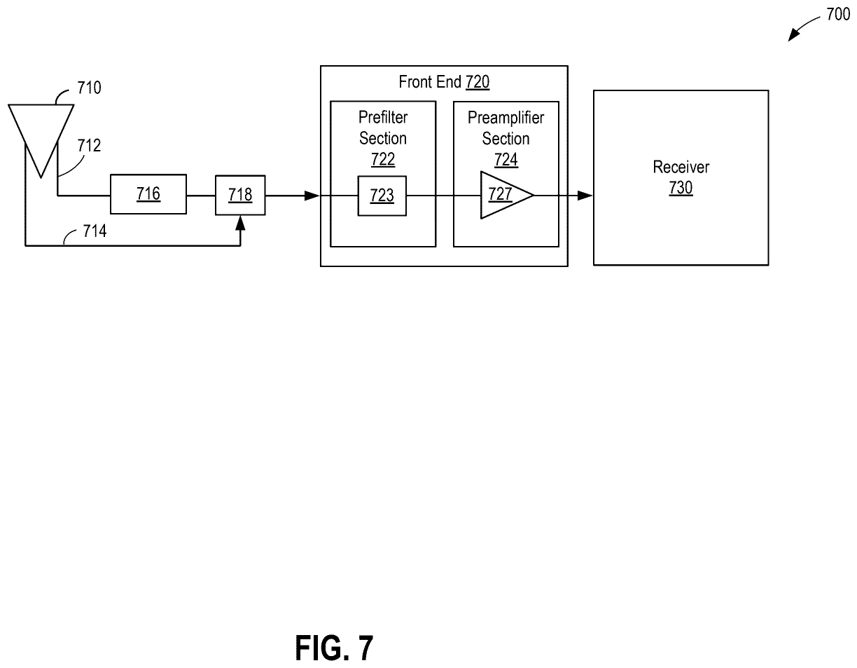

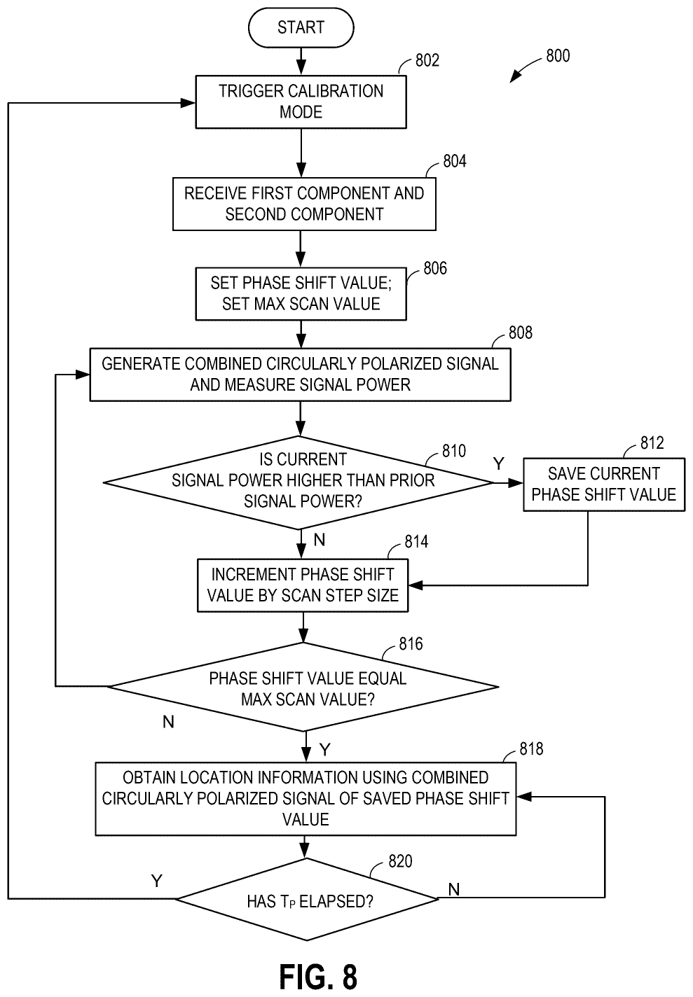

In another example, hardware processor 402 may execute instruction 410 to iteratively apply a plurality of phase delays to the first linearly polarized component. Then, for each phase delay of the plurality of phase delays, the phase delayed first linearly polarized component can be combined with the second linearly polarized component to generate a combined signal and a signal power of the combined signal can be determined (e.g., for each phased delayed first linearly polarized component). From the determined signal power for each combined signal, the combined signal having the largest signal power can be identified, which may be considered the identified signal. Additional details of this example are provided below in connection with FIGS. 7 and 8.

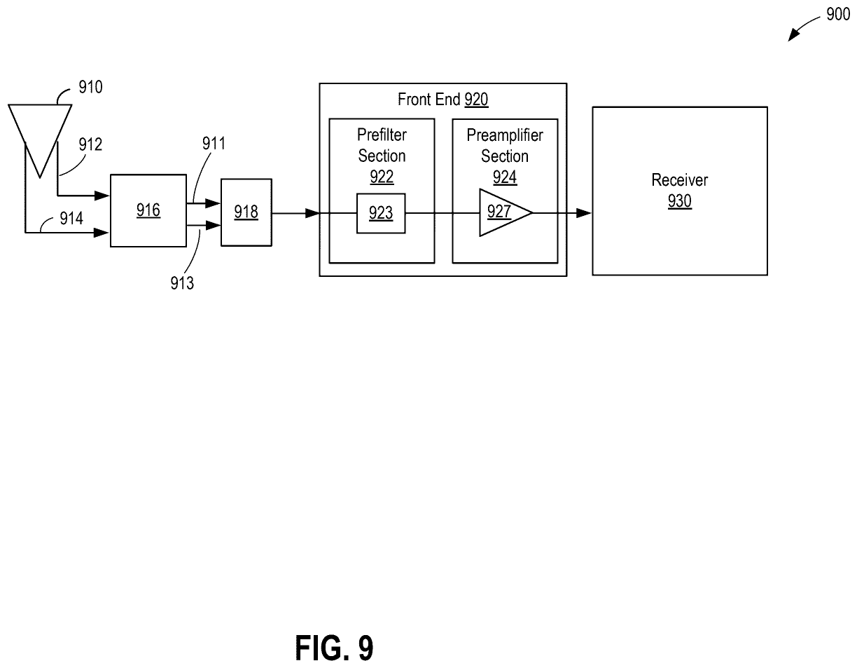

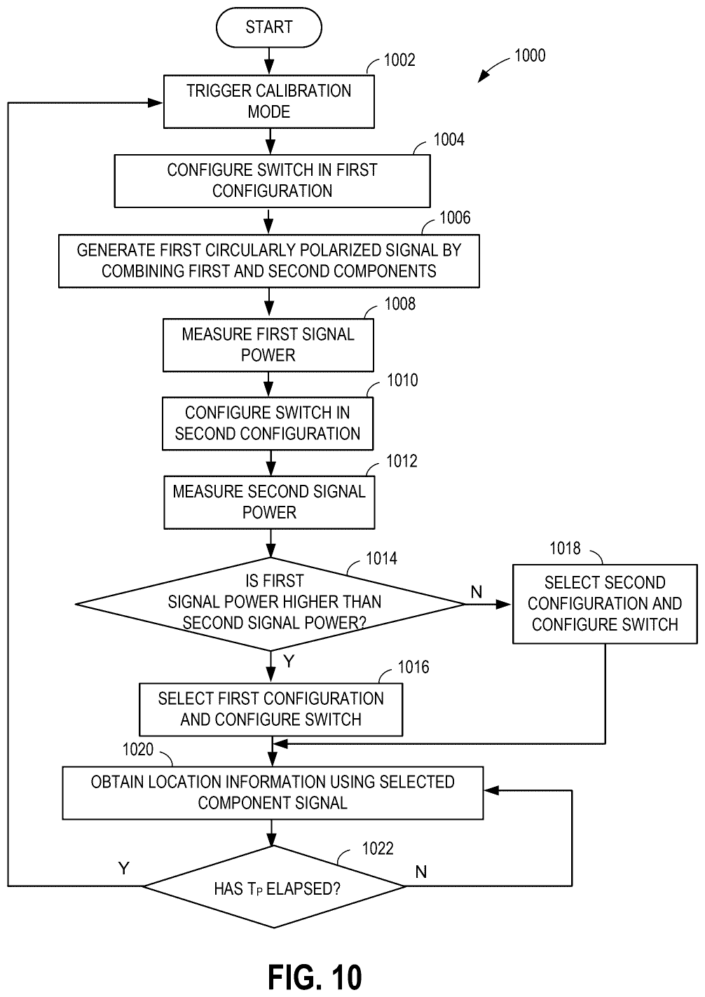

In yet another example, hardware processor 402 may execute instruction 410 to input the first linearly polarized component into a first input of a switch and the second linearly polarized component into a second input of the switch. The switch may output a first combined circularly polarized signal. The inputs may then be flipped, for example, by inputting the first linearly polarized component into the second input and the second linearly polarized component into the first input, such that the switch outputs a second combined circularly polarized signal. The first signal power of the first combined circularly polarized signal can be compared to that of the second combined circularly polarized signal to determine which is larger, and the larger on can be considered the identified signal. Additional details of this example are provided below in connection with FIGS. 9 and 10.

Hardware processor 402 may execute instruction 412 to obtain geographic coordinates for the access points from the identified signal. For example, using the signal identified by instructions 410, the receiver may demodulate the identified signal and obtain the location information encoded thereon, as described above in connection with FIGS. 1A and 4. From the location information, the receiver may estimate its geographic position by resolving geographic coordinates, which can be inferred as the geographic coordinates of the network device.

As described above, the network device may take certain actions based on the obtained geographic coordinates. For example, the network device may resolve locations for other devices on the network. As another example, the network device may self-report its location for provisioning of U-NII frequency bands for use by the network device in rendering network services.

In some examples, computing platform 400 may execute a subset of instructions 406-412. For example, computing platform 400 may include an AP and a remote server. In this case, the AP may perform instructions 406-410 and the server may perform instructions 412. In another example, the AP may be perform instructions 406-412. In yet another example, machine-readable storage media 404 may be located on a cloud-based storage, which can accessed to perform instructions 406-412 at a late time as resources become available. In another example, an AP can collect signals at different times with different settings, and then store the information for post processing by a remote processor, which can be configured to stitch together optimized settings after the fact of signal collection.

FIG. 5 is a schematic block diagram of another example receiver 500, in accordance the implementations of the present disclosure.

As described above, GNSS receivers may need to operate in different L-bands. Accordingly, receiver 500 comprises a plurality of sub-receivers 505a-505n (collectively referred to herein as sub-receivers 505), each of which corresponds to a different L-band (e.g., L1, L2, L5, etc.). In the illustrative example of FIG. 5, receiver 500 comprises a first sub-receiver 505a configured to operate in a first L-band (e.g., the L1 band) and a second sub-receiver 505n configured to operate in a second L-band (e.g., the L5 band).

The first sub-receiver 505a may be substantially similar to receiver 300 of FIG. 3, except that the prefilter section 522a may be configured to remove signals outside the L1 band. Thus, antenna 510a, which receives circular polarized signals broadcasted by a positioning system (e.g., positioning system 170 of FIG. 1A), may be substantially similar to antenna 310. Antenna 510a captures first and second components of the circularly polarized signals and communicates the components to the front end 520a via first component path 512a and second component path 514a, respectively. Prefilter section 522a comprises filters 523a and 525a that function to filter the first and second components, as described above in connection with FIG. 4. The filtered signals can be provided to preamplifier section 524a, which comprises LNAs 527a and 529a configured to amplify the respectively filtered component. The amplified components are provide to a processing engine 530 that is substantially similar to processing engine 330 as described above.

The second sub-receiver 505n may be substantially similar to sub-receiver 505a, except that the prefilter section 522n may be configured to remove signals outside the L5 band. Thus, antenna 510n, which receives circular polarized signals broadcasted by a positioning system (e.g., positioning system 170 of FIG. 1A), may be substantially similar to antenna 510a. Antenna 510n captures first and second components of the circularly polarized signals and communicates the components to the front end 520n via first component path 512n and second component path 514n, respectively. Prefilter section 522n comprises filters 523n and 525n that function to filter the first and second components, as described above. The filtered signals are provided to preamplifier section 524n, which comprises LNAs 527n and 529n configured to amplify the respectively filtered component. The amplified components are provide to a processing engine 530 that is substantially similar to processing engine 330 as described above.

FIG. 6 is a flow chart of example calibration process 600, in accordance with an example implementation. Process 600 can be implemented as instructions stored in a memory that can be executed by a controller (e.g., controller of processing engine 330) to calibrate receiver 500 of FIG. 3, as well one or more sub-receivers 505a-505n of FIG. 5. Calibration process 600 may be executed by a receiver (or sub-receiver) to select a signal for use in determining a location of the receiver based on positioning signals (e.g., positioning signals 174A-174C) from a positioning system.

At block 602, calibration mode can be triggered, for example, a controller of the receiver (or sub-receiver) may cause the receiver to enter calibration mode. For example, a circularly polarized signal may be received at an antenna (e.g., antenna 310, antenna 510a, and/or antenna 510b) and linearly polarized components of the circularly polarized signal detected. In some examples, as described above, linearly polarized components of a circularly polarized signal can be amplified and directed to a processing engine for down conversion and demodulation to obtain the location information contained thereon, as described above. Prior to down conversion and demodulation, the receiver (or sub-receiver) may enter calibration mode at block 602.

At block 604, a first linearly polarized component of the circularly polarized signal can be read for calibration time window (T_{C}) to obtain a first signal power. For example, a receiver (or sub-receiver depending on the implementation), using an antenna, may detect the first linearly polarized component (e.g., vertically linearly polarized component) and measure a signal power of the first linearly polarized component over the calibration time window. The calibration time window may be a set in advance at a first time scale (e.g., 10 seconds, 20 seconds, 1 minute, etc.). In some examples, the first linearly polarized component may be communicated to a processing engine via a first component path, as described above in connection with FIGS. 3 and 5. As such, the first signal power can be measured from a signal output from an LNA or prior to amplification of the LNA. Signal power herein may be provided as one or more of a receiver signal level (RSSI) and a carrier to noise (C/N) level. Thus, for example, processing engine 330 may receive reads outputs from the front end 320 and provide a RSSI and/or C/N values.

At block 606, a second linearly polarized component of the circularly polarized signal can be read for the calibration time window (T_{C}) to obtain a second signal power. For example, a receiver (or sub-receiver depending on the implementation), using an antenna, may detect the second linearly polarized component (e.g., horizontal linearly polarized component) and measure a signal power of the second linearly polarized component over the calibration time window. In some examples, the second linearly polarized component may be communicated to a processing engine via a second component path, as described above in connection with FIGS. 3 and 5. As such, the second signal power can be measured from a signal output from an LNA or prior to amplification of the LNA.

At determination block 608, the first signal power is compared to the second signal power to determine if the first signal power is larger than the second signal power. If the determination is affirmative, calibration process 600 proceeds to block 610 where the first linearly polarized component can be selected. Whereas, if the determination is negative, calibration process 600 proceeds to block 612 to select the second linearly polarized component. For example, the controller may determine that the first signal power is larger than the second signal power, identify the first signal power as optimal for use in obtaining positioning information (e.g., has the largest signal power), and select the linearly polarized component that corresponds to the identified signal power.

At block 614, the linearly polarized component selected at block 610 or block 612 can be used to obtain location information. For example, a controller may execute down conversion and demodulation of the selected linearly polarized component to obtain location information contained thereon and resolve geographic coordinates of the receiver, as described above.

At determination block 616, a determination is made on if a measuring time window (T_{P}) has elapsed or not. The measuring time window (T_{P}) may be set in advance to define an amount of time until the receiver may need to be recalibrated. For example, as satellites of a positioning system orbit the earth, the location of the satellites change relative to the receiver, particularly a stationary receiver. As positions of the satellites change, the traversal path of the positioning signals emitted from the satellites to the receiver change, which can cause a change in the number of reflections and/or a change in signal strength of the circularly polarized signal. Additionally, as the positions change due to orbits, the satellites from which a signal is received may change (e.g., a signal from a given satellite may no longer be received and a signal from new satellite may be received). These changes may impact which linearly polarized component provides the larger signal power, such that the receiver may need to be recalibrated to ensure the optimal linearly polarized component is used for obtaining the location information. As such, the measuring time window (T_{P}) may be set to a second time scale, larger than the first time scale, to allow for changes in positions. The measuring time window (T_{P}) may be set, in some cases, to 30 minutes or more, for example, 1 hour, 4 hours, 5 hours, etc. In some examples, the measuring time window (T_{P}) need not be constrained by the first time scale. In this case, the measuring time window (T_{P}) may be on the order to seconds or milliseconds.

If the determination at determination block 616 is negative, calibration process 600 returns to block 614 and continues to use the linearly polarized component selected at block 612 or block 610. Whereas, if the determination is affirmative, calibration process 600 returns to block 602 and triggers calibration mode to recalibrate the receiver (or sub-receiver).

In an example, process 600 can be repeated for each the measuring time window (T_{P}) and determinations stored for post processing. In this case, process 600 may not select a component for obtaining location information until the stored determinations are processed to identify the largest component signal from the scan. The process 600 may then use this component signal for obtaining location information.

FIG. 7 is a schematic block diagram of another example receiver 700, in accordance the implementations of the present disclosure. The receiver 700 may be substantially similar to receiver 300 of FIG. 3, except that a phase calibration mechanism 716 and a combiner 718 are provided along at least one of the component paths. Thus, antenna 710, which receives circular polarized signals broadcasted by a positioning system (e.g., positioning system 170 of FIG. 1A), may be substantially similar to antenna 310. Similarly, RF front end 720, pre-filter section 722, filter 723, preamplifier section 724, LNA 727, and processing engine 730 may be substantially similar to RF front end 320, pre-filter section 322, filter 323, preamplifier section 324, LNA 327, and processing engine 330 of FIG. 3, respectively.

In the example of FIG. 7, the phase calibration mechanism 716 is provided along first component path 712 and combiner 718 is connected to both the first and second component paths 712 and 714. The phase calibration mechanism 716 may be configured to adjust a phase of the first component of a circularly polarized signal received by antenna 710, which may be substantially similar to antenna 310 and/or antenna 510a, thereby inducing a phase delay on the first component. The phase calibration mechanism 716 may comprise combinations of inductors and capacitors circuit and/or different transmission line lengths that introduce phase delays. In some examples, the phase calibration mechanism 716 can be a semiconductor based phase delay integrated circuit. While the example herein depicts phase calibration mechanism 716 as provided on first component path 712, in another example, phase calibration mechanism 716 may be provided on second component path 714 to delay the phase of the second component.

The combiner 718 may be configured to generate a combined circularly polarized signal based on combining the phase delayed first component with the second component. For example, combiner 718 receives both components from the first and second component paths at inputs and outputs a combined circularly polarized signal at an output. In an illustrative example, the combiner 718 may be a RHCP combiner that generates a combined RHCP signal by combining the phase delayed first component with the second component. In this case, the first component may lag behind the second component due to the phase delay and the resulting combined signal has RHCP. In another example, the combiner 718 may generate a combined LHCP signal.

Furthermore, as described above, receivers may need to operate in different L-bands. Accordingly, a receiver may comprise a plurality of sub-receivers, each being substantially similar to the receiver 700 shown in FIG. 7, each of which corresponds to a different L-band (e.g., L1, L2, L5, etc.), similar to the example shown in FIG. 5.

FIG. 8 is a flow chart of another example calibration process 800, in accordance with an example implementation. Process 800 can be implemented as instructions stored in a memory that can be executed by a controller (e.g., controller of processing engine 730) to calibrate receiver 700 of FIG. 7. Calibration process 800 may be executed by a receiver (or sub-receiver) to select a signal for use in determining a location of the receiver based on positioning signals (e.g., positioning signals 174A-174C) from a positioning system.

At block 802, calibration mode can be triggered, for example, a controller of the receiver (or sub-receiver) may cause the receiver to enter calibration mode. For example, a circularly polarized signal may be received at an antenna (e.g., antenna 710) and linearly polarized components of the circularly polarized signal detected (block 804). In some examples, as described above, linearly polarized components of a circularly polarized signal can be amplified and directed to a processing engine for down conversion and demodulation to obtain the location information contained thereon, as described above. Prior to down conversion and demodulation, the receiver (or sub-receiver) may enter calibration mode at block 802.

At block 804, the first and second components are read for a calibration time window (T_{C}). For example, a receiver (or sub-receiver depending on the implementation), using an antenna, may detect the first and second linearly polarized component (e.g., horizontal linearly polarized component) and over the calibration time window. The calibration time window may be a set in advance at a first time scale (e.g., 10 seconds, 20 seconds, 1 minute, etc.).

At block 806, a phase shift value and a max scan value may be set. In an example, the phase shift value may be set to zero and the max scan value set to 180 degrees. In some cases, block 806 may also include setting a step value for incrementing the phase shift value. In some examples, the step value may be set to 5 degrees, but other step values may be applicable depending on the desired granularity.

At block 808, a combined circularly polarized signal can be generated and a signal power of the combined circularly polarized signal can be measured. For example, the first and second components may be passed to the combiner 718 and combined by combiner 718 to output a circularly polarized signal (e.g., RHCP in some examples). Note that at the first instance, the phase calibration mechanism 716 is set to zero and does not adjust the phase of the first component for the first instance. In an example, measuring a signal power can include measuring a collective power of energy (e.g., RSSI) of the combined circularly polarized signal. In another example, measuring a signal power may include evaluating a C/N value of a decoded satellite or a plurality of satellites.

At determination block 810, the measured signal power is compared to a preceding signal power to determine if the current measured signal power is larger than the preceding signal power. If so, the current phase shift value is stored in a memory of processing engine 730 at block 812 and the phase shift value is incremented by the step size at block 814. If the current signal power is less than the preceding signal power, the phase shift value is incremented by the step size at block 814, without saving the current phase shift value.

At determination block 816, the current phase shift value is compared to the max scan value to determine if the scan is complete. If not, calibration process 800 returns to block 808 and repeats blocks 808-816 for the next step value as incremented by block 816.

Otherwise, calibration process 800 proceeds to block 818 and obtains location information using a combined circularly polarized signal generated according to the saved phase shift value. That is, by iteratively incrementing the phase shift value and storing the phase shift value associated with the largest signal power, the circularly polarized signal having the largest signal power can be identified and selected for obtaining location information. The controller may execute down conversion and demodulation of the selected circularly polarized signal to obtain location information contained thereon and resolve geographic coordinates of the receiver, as described above.

At determination block 820, a determination is made on if a measuring time window (T_{P}) has elapsed or not. The measuring time window (T_{P}) may be set in advance to define an amount of time until the receiver may need to be recalibrated. Block 820 may be substantially similar to block 616 of FIG. 6. If the determination at determination block 820 is negative, calibration process 800 returns to block 818 and continues to use the combined circularly polarized signal to obtain location information. Whereas, if the determination is affirmative, calibration process 800 returns to block 802 and triggers calibration mode to recalibrate the receiver (or sub-receiver).

Note that no matter how many reflections the satellite signal goes through, calibration process 800 will pick up the two linear components and process them separately and calibrate one of them to change its phase to generate a combined circularly polarized signal. In implementations in which receiver 700 is included in APs, APs are generally stationary devices and hence, the surrounding environment won't change a lot over time and the reflected wave picked up by the antenna may have the same behavior over time.

FIG. 9 is a schematic block diagram of another example receiver 900, in accordance the implementations of the present disclosure. The receiver 900 may be substantially similar to receiver 300 of FIG. 3, except that a switch 916 and a circular polarization combiner 918 provided along the first and second component paths 912 and 914. Thus, antenna 910, which receives circular polarized signals broadcasted by a positioning system (e.g., positioning system 170 of FIG. 1A), may be substantially similar to antenna 310. Similarly, RF front end 920, pre-filter section 922, filter 923, preamplifier section 924, LNA 927, and processing engine 930 may be substantially similar to RF front end 320, pre-filter section 322, filter 323, preamplifier section 324, LNA 327, and processing engine 330 of FIG. 3, respectively.

In the example of FIG. 9, the switch 916 may connect two inputs to two outputs. Switch 916 may be controlled change its configuration to flip which input is connected to which output. For example, as shown in FIG. 9, first component path 912 may be connected to a first input, while second component path 914 may be connected to a second input. A first output 911 and a second output 913 may be connected to the circular polarization combiner 918. Switch 916 may be implemented, for example, as a DPDT diamond configuration switch or any switch capable of taking two inputs and connecting them to two outputs interchangeably.

In a first configuration, the first input may connect the first component path 912 to the first output 911 such that the first component is passed to the first output 911, and the second input may connect the second component path 914 to the second output 913 such that the second component is passed to the second output 913.

The switch 916 can be controlled to change to a second configuration, in which the outputs are flipped. For example, in the second configuration, the first input may connect the first component path 912 to the second output 913 such that the first component is passed to the second output 913, and the second input may connect the second component path 914 to the first output 911 such that the second component is passed to the first output 911.

The circular polarization combiner 918 may have a first input connected to the first output 911 and a second input connected to the second output 913. Circular polarization combiner 918 may be similar to combiner 718 of FIG. 7, such that circular polarization combiner 918 is configured to generate a combined circularly polarized signal based on combining the first and second components at the inputs and generating a combined circularly polarized signal at an output of circular polarization combiner 918. When the switch 916 is in the first configuration, the first component on first output 911 is combined with the second component on second output 913 to generate a first circularly polarized signal. Whereas, when the switch 916 is in the second configuration, the second component on first output 911 is combined with the first component on second output 913 to generate a second circularly polarized signal, having a rotation direction opposite of the first circularly polarized signal. For example, where the first component is vertically linearly polarized and the second component is horizontal linearly polarized, the first circularly polarized signal may have RHCP when the switch 916 is in the first configuration and the second circularly polarized signal may have LHCP when the switch 916 is in the second configuration.

Furthermore, as described above, receivers may need to operate in different L-bands. Accordingly, a receiver may comprises a plurality of sub-receivers, each being substantially similar to the receiver 900 shown in FIG. 9, each of which corresponds to a different L-band (e.g., L1, L2, L5, etc.), similar to the example shown in FIG. 5.

FIG. 10 is a flow chart of another example calibration process 1000, in accordance with an example implementation. Process 1000 can be implemented as instructions stored in a memory that can be executed by a controller (e.g., controller of processing engine 930) to calibrate receiver 900 of FIG. 9. Calibration process 1000 may be executed by a receiver (or sub-receiver) to select a signal for use in determining a location of the receiver based on positioning signals (e.g., positioning signals 174A-174C) from a positioning system.

At block 1002, calibration mode can be triggered, for example, a controller of the receiver (or sub-receiver) may cause the receiver to enter calibration mode. For example, a circularly polarized signal may be received at an antenna (e.g., antenna 910) and linearly polarized components of the circularly polarized signal detected. In some examples, as described above, linearly polarized components of a circularly polarized signal can be amplified and directed to a processing engine for down conversion and demodulation to obtain the location information contained thereon, as described above. Prior to down conversion and demodulation, the receiver (or sub-receiver) may enter calibration mode at block 1002.

At block 1004, a switch may be configured in a first configuration. For example, as described above, switch 916 may be controlled via processing engine 930 to connect first component path 912 to first output 911 and connect second component path 914 to second output 913. In this configuration, the first component can be passed to first output 911 and the second component passed to second output 913 for a calibration time window (T_{C}). As described above, the calibration time window may be a set in advance at a first time scale (e.g., 10 seconds, 20 seconds, 1 minute, etc.)

At block 1006, a combined first circularly polarized signal can be generated by combining the first and second components. For example, the first component may be passed to the circular polarization combiner 918 via first output 911, while the second component passed to circular polarization combiner 918 via second output 913. The first and second components can be combined by circular polarization combiner 918 to output the first combined circularly polarized signal (e.g., RHCP in some examples).

At block 1008, a first signal power of the first combined circularly polarized signal can be measured.

At block 1010, the switch may be flipped to a second configuration. For example, as described above, switch 916 may be controlled via processing engine 930 to connect first component path 912 to second output 913 and connect second component path 914 to first output 911. In this configuration, the first component can be passed to second output 913 and the second component passed to first output 911 for the calibration time window (T_{C}).

At block 1012, a second signal power of a second combined circularly polarized signal can be measured. For example, the second combined circularly polarized signal can be generated by combining the first and second components. That is, the first component may be passed to the circular polarization combiner 918 via second output 913, while the second component passed to circular polarization combiner 918 via first output 911. The first and second components can be combined by circular polarization combiner 918 to output the second combined circularly polarized signal that has an direction of rotation opposite of the first combined circularly polarized signal (e.g., LHCP in some examples). The signal power of the second combined circularly polarized signal can thus be measured at block 1012.

At determination block 1014, the first signal power is compared to the second signal power to determine if the first signal power is larger than the second signal power. If the determination is affirmative, calibration process 1000 proceeds to block 1016 where the first combined circularly polarized component can be selected and the switch configured according to the first configuration. Whereas, if the determination is negative, calibration process 1000 proceeds to block 1018 to select second combined circularly polarized component and configure the switch according to the second configuration.

At block 1020, the combined circularly polarized component selected at block 1016 or block 1018 can be used to obtain location information. For example, a controller may execute down conversion and demodulation of the selected combined circularly polarized to obtain location information contained thereon and resolve geographic coordinates of the receiver, as described above.

At determination block 1022, a determination is made on if a measuring time window (T_{P}) has elapsed or not. The measuring time window (T_{P}) may be set in advance to define an amount of time until the receiver may need to be recalibrated. Block 1022 may be substantially similar to block 616 of FIG. 6. If the determination at determination block 1022 is negative, calibration process 1000 returns to block 1020 and continues to use the selected combined circularly polarized signal to obtain location information. Whereas, if the determination is affirmative, calibration process 1000 returns to block 1002 and triggers calibration mode to recalibrate the receiver (or sub-receiver).

FIG. 11 depicts a block diagram of an example computer system 1100 in which various of the examples described herein may be implemented. The 1100 may be implemented as network controller 104 of FIG. 1A, processing engine 330 or controller 332 of FIG. 3, processing engine 530a or processing engine 530b (or controllers therein), processing engine 730 of FIG. 7, and/or processing engine 930 of FIG. 9. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions. In some examples, main memory 1106 may store instructions that can be executed by processor 1104 to perform operations described in connection with FIGS. 4, 6, 8, and 10.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

The computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some embodiments, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

The computer system 1100 also includes a communication interface 1118 coupled to bus 1102. Communication interface 1118 provides a two-way data communication coupling to one or more network links that are connected to one or more local networks. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN (or WAN component to communicated with a WAN). Wireless links may also be implemented. In any such implementation, communication interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1118, which carry the digital data to and from computer system 1100, are example forms of transmission media.

The computer system 1100 can send messages and receive data, including program code, through the network(s), network link and communication interface 1118. In the Internet example, a server might transmit a requested code for an application program through the Internet, the ISP, the local network and the communication interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for tuning an access point comprising:
receiving, by an antenna of the access point, a circularly polarized signal;
obtaining a first linearly polarized component of the circularly polarized signal and a second linearly polarized component of the circularly polarized signal;
identifying a signal having a largest signal power based on a comparison comprising the first and second linearly polarized components;
obtaining geographic coordinates for the access points from the identified signal; and
connecting to a network based on the obtained geographic coordinates.

2. The method of claim 1, wherein the circular polarized signal is a right-handed circularly polarized signal.

3. The method of claim 2, wherein the circular polarized signal is a Global Navigation Satellite System (GNSS) signal.

4. The method of claim 1, wherein the first linearly polarized component is orthogonal to the second linearly polarized component.

5. The method of claim 1, further comprising:
determining a first signal power of the first linearly polarized component is larger than a second signal power of the second linearly polarized component by comparing the first signal power to the second signal power,
wherein the identified signal is the first linearly polarized component.

6. The method of claim 1, further comprising:
iteratively applying a plurality of phase delays to the first linearly polarized component;
for each phase delay of the plurality of phase delays,
combining the phase delayed first linearly polarized component with the second linearly polarized component to generate a combined signal, and
determining a signal power of the combined signal; and
identifying a combined signal of the plurality of phase delays having the largest signal power,
wherein the identified signal is the identified combined signal.

7. The method of claim 6, wherein the combined signal is a circularly polarized signal.

8. The method of claim 1, further comprising:
inputting the first linearly polarized component into a first input of a switch and the second linearly polarized component into a second input of the switch to output a first combined circularly polarized signal;
inputting the first linearly polarized component into the second input of a switch and the second linearly polarized component into the first input of switch to output a second combined circularly polarized signal; and
determining a first signal power of the first combined circularly polarized signal is larger than a second signal power of the second combined circularly polarized signal by comparing the first signal power to the second signal power,
wherein the identified signal is the first combined circularly polarized signal.

9. The method of claim 8, wherein the first combined circularly polarized signal is a right-handed circularly polarized signal, and wherein the second combined circularly polarized signal is a left-handed circularly polarized signal.

10. An access point, comprising:
an antenna;
a memory storing instructions; and
at least one processor communicatively coupled to the antenna and the memory and configured to execute the instructions to:
receive, by the antenna, a position signal from a positioning system, the positioning signal comprising a right-hand circularly polarized signal;
obtain a first linearly polarized component of the positioning signal and a second linearly polarized component of the positioning signal;
select a signal having a largest signal power based on a comparison comprising the first and second linearly polarized components;
determine geographic coordinates for the access points based on the selected signal; and
render network services based on the obtained geographic coordinates.

11. The access point of claim 10, wherein the antenna is a dual-polarized antenna.

12. The access point of claim 10, wherein the positioning signal is a Global Navigation Satellite System (GNSS) signal.

13. The access point of claim 10, wherein the first linearly polarized component is a vertical linearly polarized component and the second linearly polarized component is a horizontal linearly polarized component.

14. The access point of claim 10, wherein the at least one processor is further configured to execute the instructions to:
determine a first signal power of the first linearly polarized component is larger than a second signal power of the second linearly polarized component by comparing the first signal power to the second signal power,
wherein the selected signal is the first linearly polarized component.

15. The access point of claim 10, further comprising:
a phase calibration mechanism connected to the antenna; and
a combiner connected to the phase calibration mechanism.

16. The access point of claim 15, wherein the at least one processor is further configured to execute the instructions to:
iteratively apply, by the phase calibration mechanism, a plurality of phase delays to the first linearly polarized component;
for each phase delay of the plurality of phase delays,
combine, by the combiner, the phase delayed first linearly polarized component with the second linearly polarized component to generate a combined signal, and
determine a signal power of the combined signal; and
identify a combined signal of the plurality of phase delays having the largest signal power,
wherein the selected signal is the identified combined signal.

17. The access point of claim 10, further comprising:
a switch comprising a first input and a second input connected to the antenna; and
a circular polarization combiner having a first input connected to a first output of the switch and a second input connected to a second output of the switch.

18. The access point of claim 17, wherein the at least one processor is further configured to execute the instructions to:
configure the switch in a first configuration, wherein, when in the first configuration, the first linearly polarized component is passed into the first input of the switch and the second linearly polarized component is passed into the second input of the switch in the first configuration;
output a first combined circularly polarized signal from the circular polarization combiner when the switch is in the first configuration;
configure the switch in a second configuration, wherein, when in the second configuration, the first linearly polarized component is passed into the second input of the switch and the second linearly polarized component is passed into the first input of the switch;
output a second combined circularly polarized signal from the circular polarization combiner when the switch is in the second configuration; and
determine a first signal power of the first combined circularly polarized signal is larger than a second signal power of the second combined circularly polarized signal by comparing the first signal power to the second signal power,
wherein the selected signal is the first combined circularly polarized signal.

19. A Global Navigation Satellite System (GNSS) receiver comprising:
a dual-polarized antenna configured to detect a first linearly polarized component of a GNSS signal and a second linearly polarized component of a GNSS signal; and
a controller connected to the dual-polarized antenna, the controller configured to select an optimal signal based on a comparison comprising the first and second linearly polarized components and resolve geographic coordinates using the optimal signal.

20. The GNSS receiver of claim 19, wherein selecting the optimal signal is based on identifying a signal having a largest signal power from the comparison comprising the first and second linearly polarized components.
